(19) United States
(12) Patent Application Publication
(10) Pub. No.: US 2010/0066488 A1
(43) Pub. Date: Mar. 18, 2010

(54) SYSTEM AND METHOD FOR VALIDATED GUEST REVIEWS

(76) Inventor: Alan Roy Hollander, Needham, MA (US)

Correspondence Address: Alan Hollander, 97 Meetinghouse Circle, Needham, MA, 02492, US

(21) Appl. No.: 12/490,713

(22) Filed: Jun. 24, 2009

Related U.S. Application Data
(60) Provisional application No. 61/098,216, filed on Sep. 18, 2008.

(51) Int. Cl. G05B 19/00

(52) U.S. Cl. 340/5.8

(57) ABSTRACT

The present invention relates to a validation system and method which enables a guest review website to prevent people from posting reviews of hotels without having an invitation with a unique identifier generated by an independent service provider.

### CROSS-REFERENCE TO RELATED APPLICATION

This application claims priority under 35 USC 119(e) to provisional application Ser. No. 61/098,216, filed Sep. 18, 2008.

### BACKGROUND OF THE INVENTION

1. Field of the Invention

The present invention relates to a validation system and method which enables a guest review website on the Internet to validate that a guest posting a review of a hotel has actually stayed at the hotel.

2. Brief Description of Related Developments

Online guest reviews have an influence on the selection a hotel prior to making a reservation. For purposes herein a reference to a “hotel” includes all types of lodging such as hotels, motels, bed & breakfasts, inns, vacation rentals, and cruise ships. As a result, online guest reviews constitute valuable content that can enable a website such as TripAdvisor or Yelp to attract visitors and thereby generate revenue from advertising. Also, online search engines such as Google, Yahoo, and Microsoft's Bing use abbreviated third-party guest reviews posted on such websites as part of the results to users who are searching for hotels in a particular city. These abbreviated reviews link to the websites where the reviews are posted and thereby funnel users to these websites.

Sometimes competitors, disgruntled employees, or others post reviews on guest review websites in an attempt to deter potential guests from booking at the hotel being reviewed. It is well-recognized that guest review websites such as TripAdvisor and Yelp and others enable people to post reviews of hotels even if they have not actually stayed at these hotels.

As a result of the foregoing, a system whereby a review of a hotel can be posted on a guest review website only by a guest who has actually stayed at the hotel would prevent many people who have not actually stayed at the hotel from being able to post reviews.

### SUMMARY OF THE INVENTION

In accordance with the foregoing needs, there is disclosed a method and system whereby a hotel generates invitations, each with a unique identifier, from a service provider, provides those invitations to its guests, and the guests post reviews at a website managed and hosted by the service provider, using only the unique identifier to validate their stay at the hotel, without the need for the service provider to obtain any information from the hotel about the guest.

A hotel is associated with a specific identifier (a “Hotel ID”) when it registers for the service from the service provider. A hotel generates invitations by securely logging into a server maintained by the service provider. Each invitation so generated contains a unique identifier (a “Guest ID”). The invitations can be generated in a manner to be printed and delivered to guests at the hotel, or delivered electronically to a guest. Each Guest ID used in an invitation is simultaneously associated in the database to the Hotel ID of the hotel that generates the invitation. When a guest uses the Guest ID to login to the guest review website, the Guest ID is checked to determine that it has been associated to a Hotel ID and to determine that it has not been previously used. It can also be checked to determine that it has not expired. A Guest ID is previously used if it has been used to login to the guest review website previously. A Guest ID can be set to expire after a specified period after a Hotel ID has been associated to the Guest ID. The expiration period can be used to ensure that guest reviews are posted within a certain period of time from the date the invitations are generated.

A hotel can decline to issue an invitation to any guest the hotel suspects may be acting on behalf of a competitor or disgruntled employee, by, for example, declining to issue an invitation based on the nearby location of the guest's residence in relation to the hotel.

The methods discussed above are examples and not restrictions on how the invention may be practiced. For example, these methods may include additional acts or steps. Further, the order of the acts performed as part of these methods is not limited to the order described, unless the context clearly requires, as the acts may be performed in other orders, and one or more of the acts may be performed in series or in parallel to one or more other acts, or parts thereof. None of the claims set forth below is intended to be limited to any particular implementation unless such claim includes a limitation explicitly reciting a particular implementation.

It should be appreciated that any single component or collection of multiple components of a computer system that perform the functions described above with respect to, or with reference to, the method can be generically considered as one or more controllers that control the above-discussed functions. The one or more controllers can be implemented in numerous ways, such as with dedicated hardware, or using a processor that is programmed using microcode or software to perform the functions recited above. Data processing aspects of the invention may be implemented in software, hardware or firmware, or any combination thereof. Further, such methods, acts, systems, system elements and components thereof may be implemented as part of the computer system described above or as an independent component. It should be understood that the invention is not limited to a particular computer system platform, processor, operating system, or network. Also, it should be apparent to those skilled in the art that the present invention is not limited to a specific programming language or computer system.

Having thus described an inventive concept and embodiments for practicing such concept, it will be appreciated that the embodiments discussed herein are presented by way of example only and are not intended as limiting. Various alterations thereto and other embodiments will readily occur to those skilled in the art and it is intended that they be suggested by this disclosure. Moreover, although some of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function. The invention is thus limited only as required by the following claims and equivalents thereto.

What is claimed is:

1. A system and method for validating that a person who posts a review of a hotel on a guest review website has actually stayed at the hotel, comprising:
a. an application and database residing on one or more servers managed by a service provider,
b. one or more hotels registering with the service provider and each receiving a unique registration number (a “Hotel ID”),
c. each registered hotel having the ability to securely login to one of the servers over the Internet and generate unique identifiers consisting of computer keyboard characters (Guest ID's),
d. the database associating each Guest ID generated with the Hotel ID of the hotel which generates the invitation,
e. the application assigning a code in the database whenever a Guest ID is used to login to one of the servers to indicate that the Guest ID is used,
f. a hotel providing an invitation in paper or electronic format to a guest, each containing a unique Guest ID,
g. a guest logging into one of the servers on the Internet and providing the Guest ID and the server validating the Guest ID by determining if there is an associated Hotel ID and that the Guest ID is not coded in the database as previously used,
h. a guest who has logged into one of the servers posting a review and the posted guest review being associated in the database with the same Hotel ID used to validate the Guest ID, and
i. reviews posted by guests whose Guest ID is validated being displayed on the Internet and each review being associated with the hotel whose Hotel ID is associated with the Guest ID used to post the review.

2. The system and method of claim 1 whereby the application assigns a code in the database whenever a Guest ID has not been used to login in the server for a specified period of time to indicate that the Guest ID is expired, and not validating expired Guest IDs.

3. The system and method of claim 1 wherein a hotel establishes certain conditions under which invitations are provided to guests.
